(19) United States
(12) Patent Application Publication
(10) Pub. No.: US 2008/0094219 A1
(43) Pub. Date: Apr. 24, 2008

(54) Privacy Protection Cleanup Shop Station and Devices

(75) Inventors: Joachim Guenster, Baldham (DE); Thomas Binzinger, Baldham (DE)

Correspondence Address: AC TECHNOLOGIES, S.A., MAISON 2, LEITHUM, 9910, omitted

(73) Assignee: AC TECHNOLOGIES S.A., Leithum (LU)

(21) Appl. No.: 11/871,299

(22) Filed: Oct. 12, 2007

Related U.S. Application Data
(60) Provisional application No. 60/829,895, filed on Oct. 18, 2006.

(51) Int. Cl. H04B 7/00

(52) U.S. Cl. 340/572.3

(57) ABSTRACT

A system and a method for disabling RFID tags that send information to a receiver by using a device capable of generate a strong electromagnetic field or any other targeted radiation of energy or particles. The system comprises a RFID tag interrogator, a display, an input device, and an EMP emitting device, all connected to a computer. The system may be built into a doorway, passage, channel or any other similar pass through or way through. It can be also built as a handheld device or into a belt running apparatus. The method is comprised of offering these systems in shopping malls, shopping centers or any other shopping facilities as well as in car wash centers.

### CROSS-REFERENCE TO RELATED APPLICATIONS

This application claims priority from U.S. Provisional Patent Application Ser. No. 60/829,895, filed on 18 Oct. 2006 and entitled “Privacy Protection Cleanup Shop Station and Devices”, the contents of which are hereby fully incorporated by reference.

### BACKGROUND OF THE INVENTION

1. Field of the Invention

This invention relates to systems and methods for disabling RFID tags to protect consumer privacy.

2. Description of the Related Art

Radio Frequency Identification (RFID) technology can be used to identify, track, sort or detect a wide variety of objects. A basic RFID system consists of a RFID tag interrogator and a RFID tag that is electronically programmed with data. Data stored in the RFID tag is retrieved by the RFID tag interrogator and transmitted to a host computer to be processed according to the needs of a particular application.

In recent years, the increasing use of RFID technology has raised questions in the areas of protection of consumer privacy. In one of its multiple applications, RFID systems are used to identify items for purchase and inventory. This requires attaching RFID tags to products so that the RFID tag interrogator is able to detect and identify such tagged products. But these RFID tags remain attached to the purchased products and are carried by the customer after shopping. If no deactivated or destroyed, the presence of such RFID tags may allow a third party to scan the products and learn the contents of the customer's purse, car or bags. Hence, RFID systems that imply for customers to become carriers of RFID tags represent a serious threat for consumer privacy.

For the foregoing reasons, there is a need for privacy systems that allow purchasers to easily disable RFID tags for example, before leaving a shopping facility.

### SUMMARY

The invention consists of a system and a method for detecting and disabling RFID tags attached to purchased goods. The invention allows customers themselves to destroy RFID tags before leaving a shopping facility in order to prevent unauthorized identification and tracking of their possessions by third parties. The system may be built into a doorway, passage, channel or any other similar pass through or way through. It can be also built as a handheld device or into a belt running apparatus.

### BRIEF DESCRIPTION OF THE DRAWINGS

For a fuller understanding of the nature and advantages of the present invention, as well as the preferred mode of use, reference should be made to the following detailed description read in conjunction with the accompanying drawing.

FIG. 1 is a flow diagram of a destruct sequence and related operations according to a preferred embodiment.

### DETAILED DESCRIPTION

### Preferred Embodiment

The present invention relates to a personal privacy management system and method. More specifically, the disclosed embodiments of the present invention are used to permanently destroy RFID tags so that is no longer possible to read the data encoded thereon.

The method consists of offering a RFID tag destruction service in an easily accessible way to the end user. This is realized by setting up the system at places with frequent customer attendance like shopping malls, shopping centers, and any other shopping facilities as well as in car wash centers or any other pass through or walk through. After customers purchase in the stores, they normally carry different products that have RFID tags attached with them. It is therefore a convenient place to offer the RFID tag destruction service.

In a preferred embodiment, the system consists at its heart of a device capable of generating a strong electromagnetic field or any other targeted radiation of energy or particles, the EMP device. The system also comprises a RFID tag interrogator, an input device, and a display, all connected to a computer.

With activation of the EMP device and provided RFID tags attached to purchased goods are put into the designated place, RFID tags receive electromagnetic pulses or any other particle emissions, which leads to an overcharge of their internal electrical parts. This overcharge renders RFID tags inoperable.

The RFID tag interrogator is a sending and receiving device that comprises an antenna packaged with a transceiver and a decoder. This RFID tag interrogator emits a constant energy field that is sufficient to charge the electrical parts of the RFID tags located within a specific area. When a RFID tag passes through the electromagnetic zone generated by the RFID tag interrogator, it detects the RFID tag interrogator activation signal. Then, the RFID tag interrogator sends an information request to the RFID tag prompting a response. Such response contains the data stored on the RFID tag that is then received by the RFID tag interrogator and subsequently transmitted to a computer.

When the RFID tag interrogator transmits the data received from the RFID tag to the computer, programming means of the system link the RFID data with a proprietary database stored on the computer. This internal database provides identification information on the detected RFID tags. The computer is also attached to an external network. When RFID identification information is missing on the internal database, the computer connects to the external network and retrieve information held in other sources, like, but not limited to, the original manufacture's system, databases belonging to the companies that handled the RFID tagged item during its track through the supply chain, etc. Additionally, the user may input RFID tagged product information of his or her knowledge to enhance the content of the system database.

Once RFID tags are identified, the system distinguishes among different categories thereof and applies anti-destruction measures. In some cases, it is not advisable to destroy RFID tags because information contained thereon is used for post-purchase applications. In other cases, RFID tags may contain very sensitive information, like but not limited to RFID tags used in passports, driving licenses or ID cards. As explained above, the system identifies the RFID tag attached to customer's items by using its proprietary RFID database and when necessary, connecting to RFID external database(s). When RFID tags are identified as corresponding to a sensitive category, the system executes the anti-destruction security proceeding. This proceeding consists of different actions depending on the level of security applicable to each sensitive category of RFID tags. In a level A, the system automatically blocks the destruction process of certain RFID tags e.g. those contained on passports. In a level B, the system only warns the user on the inconvenience of a destruction process in respect of certain RFID tagged products but the user can choice between continuing and stopping the destruction process. These two security levels are provided by way of example only. It should be understood that the anti-destruction security proceeding might include more than two security levels.

The system also included a display and an input device both connected to the computer. The input device can be a keyboard, a voice control or a touch screen version of the display, among others. The computer controls the display and the input device. The display shows instructions to the user and the status of the destruction process while the input device allows the user to direct the process.

After confirmation of the user, the EMP device emits EMP waves to disable RFID tags. It should be noted that in this description the words disable, destruction and destroy are used interchangeably and indicate that the data stored on the RFID tag can not be longer be read because of the destruction of the electronic circuit contained thereon.

The system can be built into a doorway, passage, channel or any other similar entities separating two locations. This is useful because entities separating two locations are more frequently passed by people than other places.

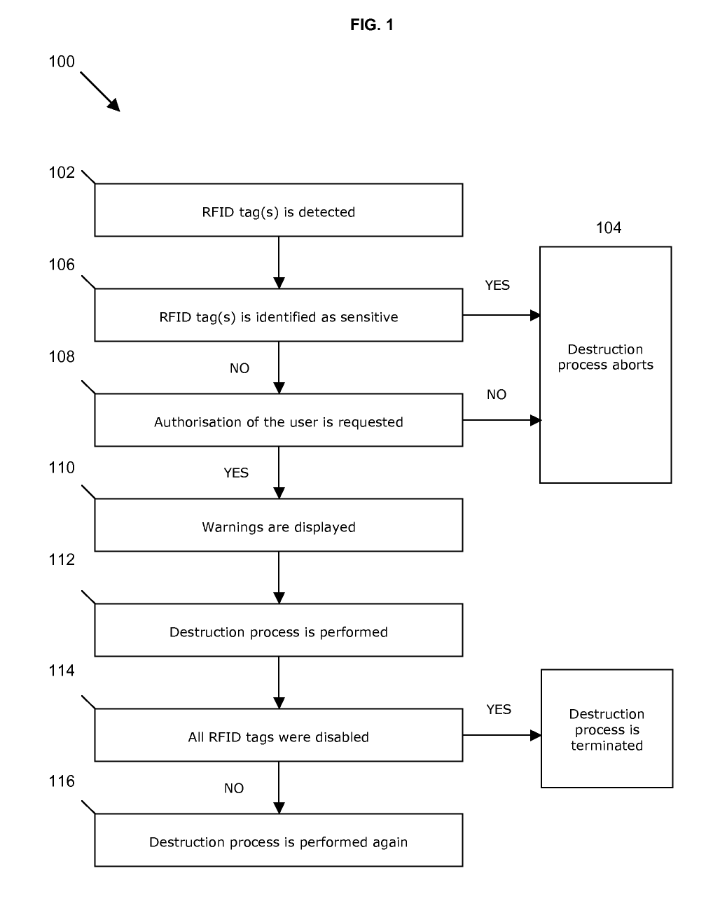

Referring now to FIG. 1, a flowchart of the method is shown. In operation 102 RFID tags to be disabled are detected when passing through the electromagnetic zone generated by the RFID tag interrogator. First, RFID tags detect the RFID tag interrogator activation signal. Then, the RFID tag interrogator sends an information requests to the RFID tags prompting a response. Such response contains the data stored on the RFID tag that is then received by the RFID tag interrogator and transmitted to the computer.

The RFID tag interrogator scans different frequencies in order to receive the responding information of the RFID tags because they potentially use different bands of frequency. The RFID tag interrogator receives the properties of the frequencies from the computer. The computer has the information of the different frequency bands stored on a storage device. Such information can be updated or exchanged in order to allow for changes in frequency bands used by the industry.

In operation 106, the computer links the data retrieved from the RFID tags with its internal database for identification. When RFID identification information is missing on the internal database, the computer connects to the external network and retrieve information held i.e. in the original manufacture's system, in databases belonging to the companies that handled the RFID tagged item during its track through the supply chain, etc. The integration of these various sources of information ensures the identification of the RFID tag.

When possible, information retrieved from external databases is stored on the computer and integrated to the proprietary database. This allows for adding permanently new RFID identification data to the proprietary database. Additionally, it optimises the response time of the system when identifying an RFID tagged item as the identification data is to be found in the internal database and not in an external source.

Once RFID tags are identified, the system distinguishes among different categories thereof and applies an anti-destruction proceeding. This proceeding consists of different actions depending on the level of security applicable to each sensitive category of RFID tags. In a level A, the system automatically blocks the destruction process of certain RFID tags e.g. those contained on passports (Operation 104). In a level B, the system only warns the user on the inconvenience of a destruction process in respect of certain RFID tagged products but the user can choice between continuing and stopping the destruction process (Operation 110). Additionally, the warnings may consist for example of not letting small children and elderly people near the machine. The system also warns against potential damages to electrical machines located within or near the scanning range (Operation 110).

In operation 108, the user is required to authorize the system to perform the destruction process in respect of non-sensitive RFID tags. The display shows the request for authorization, which is introduced by means of the input device. The system may also integrate the display and input device in a single device, i.e. a touch screen.

In operation 112, the EMP device emits EMP waves to disable RFID tags. Guiding lights show the customer the place where the items have to be placed and give him time to step back before the EMP device is activated. Sensors prevent the EMP device from working while persons are in the restricted area. Once the EMP device is activated and provided RFID tags are put into the designated place, RFID tags attached to purchased goods receive electromagnetic pulses or any other particle emissions from the EMP device. It leads to an overcharge of their internal electrical parts, rendering them inoperable.

The EMP device is shielded by means of protective metal arrays build into the device itself and into its surrounding. It thereby prohibits EMP waves to reach other areas than the one provided for the RFID tags. This is necessary, because EMP waves can potentially damage other electronic devices.

In operation 114, once the destruction process finalizes, the RFID tag interrogator scans the goods again to confirm that all detected RFID tags were disabled. When, in spite of the destruction process some of the RFID tags remain active, the user may request a second destruction process.

In operation 116, the user is requested to affirm or deny a second destruction process in respect of those RFID tag that remain operable. Operation 116 might be repeated until the display shows that all RFID tags have been destroyed. The user is requested to authorize each single repetition of the destruction process.

### Alternative Embodiments of the Invention

The system may be built as described above or it can be built more automated. It then has a sensor built into the RFID tag interrogator that is connected to the computer. By meanings of the sensor, the RFID tag interrogator is able to detect people approaching the entity in question. Then, the system reacts to those objects by promoting the service with signals like lights or by activating upon approach. The activation of the system after reaction of the sensor enables to save energy and attract attention. The system can also be equipped with lights that illuminate the area where the goods have to be placed or give information regarding the status of the destruction process by using different light colors or flashing.

The system can be built into a belt running apparatus placed in the way out areas of shopping centers, shopping malls or any other shopping facilities. The apparatus comprises a driving assembly including a motor capable of supplying movement to a belt disposed in form of U and a small covered passage where the system is built. Users place the goods on the running belt where they are guided through the destruction process. Goods are scanned and RFID tags destroyed when passing through the small passage of the belt running apparatus.

The system can also be built as a handheld device. It then has an internal and an optional external power sources to meet both mobile and stationary usage requirements. It also has lights and sensors that allow the determination of the place where the goods have to be placed and the area dangerous to be entered while the EMP device works.

The service can also be provided in car wash centers. In this embodiment, the service allows customers to scan goods placed in the car and to destroy the detected RFID tags.

The method can consist of placing the belt running apparatus or the hand held device as a self service station in a shopping mall, shopping center or any other shopping facilities. The customer is then guided by the display through the scanning and destruction process.

The destruction service can also be run by a contractor like a shop owner. It will then be controlled by service personnel.

The customer can pay the RFID destruction service in different ways, for example, by inserting money, using a credit card or using a sms payment service.

In case the shop owner contracts the service to offer it to its customers for free, the payment may be organized as a time lease, a single purchase or a fee based on transactions for example.

### CONCLUSIONS, RAMIFICATIONS, AND SCOPE OF THE INVENTION

The system and method described in this specification provides the advantage of allowing the identification of any of the RFID tagged products contained within customer's posessions, avoiding the destruction of certain RFID tags contained thereon and letting customers to follow and direct the destruction process themselves. On the other hand, retailers are able, according to their specific needs, to choose the most adequate embodiment for offering the destruction service to their customers.

Although disablement of RFID tags has been mainly described herein at point of purchase or in car wash centers, it should be understood that they have been presented by way of example only, and not limitation. It would be obvious to one skilled in the art that such disablement may be done at other times in the life cycle of the RFID tag. Thus, the breadth and scope of a preferred embodiment should not be limited by any of the above-described exemplary locations, but should be defined only in accordance with the following claims and their equivalents.

What is claimed is:

1. A method of destroying RFID tags attached to purchased products to protect consumer privacy, comprising:
a) providing a RFID tag interrogator which is able to detect the presence of RFID tags attached to purchased goods carried by a customer, said RFID tag interrogator being associated to a computer, said RFID tag interrogator detecting RFID tags working in different bands of frequency;
b) providing a computer having storage and processing means, said computer receiving, storing and processing information on RFID tags detected by said RFID tag interrogator, said computer being connected to an external network;
c) providing an internal database containing RFID identification data, said database being stored on said computer;
d) connecting to external databases to collect RFID identification data missing on said internal database;
e) integrating data collected from said external databases into said internal database;
f) providing a display for showing the presence of RFID tags on said purchased goods, said display being connected to said computer;
g) providing an input device for said customer to authorize and direct the destruction process of RFID tags, said input device being connected to said computer;
h) showing warnings about potential damages to electronics or another RFID products surrounding the location in which said destruction process is performed;
i) executing anti-destruction instructions in respect of sensitive RFID tags, said anti-destruction instructions being executed according to different security levels;
j) providing a device which is capable to destroy RFID tags by emitting electromagnetic pulses or any other particle emission, said device receiving instructions from said computer and acting only upon authorization of the customer;
k) showing the results of said destruction process on said display, said results consisting of the total number of destroyed RFID tags;
l) allowing to repeat the process after an unsuccessful attempt to destroy the RFID tags;
whereby said method is to be offered at the way out of shopping malls, shopping centers or any other shopping facilities as well as in car wash centers by implementing means for performing steps (a) (b) (c) (d) (e) (f) (g) (h) (i) (j) (k) (l) of the method into a passage, doorway, channels or any other similar entity separating to locations.

2. The method of claim 1 further including means for promoting the service and attract the attention of the customer carrying purchased goods.

3. The method of claim 1 further including means for signaling the customer the place in which purchased products are to be located for performing the destruction process of RFID tags.

4. The method of claim 1 further including different payment options for said customer to use the destruction service.

5. The method of claim 1 wherein means for performing steps (a) (b) (c) (d) (e) (f) (g) (h) (i) (j) (k) (l) are built into a belt running apparatus, said belt running apparatus comprising itself a driving assembly, a belt disposed in form of U and a covered passage whereby said driving assembly supplies movement to said belt, said belt being the place on which RFID tagged products are disposed, said belt running through said covered passage, said covered passage being the place where the destruction process is performed.

6. The method of claim 5 further including means for promoting the service and attract the attention of the customer carrying purchased goods.

7. The method of claim 5 further including means for signaling the customer the place in which purchased products are to be located for performing the destruction process of RFID tags.

8. The method of claim 5 further including different payment options for said customer to use the destruction service.

9. The method of claim 1 wherein means to perform steps (a) (b) (c) (d) (e) (f) (g) (h) (i) (j (k) (l) of the method are built into a handheld device, said handheld device having an internal and an optional external power source, said handheld device having means for signaling the place where the goods have to be placed for the destruction process of RFID tags.

10. The method of claim 9 further including different payment options for said customer to use the destruction service.

11. A system for disabling radio frequency identification (RFID) tags, said system comprising:
a) a RFID tag interrogator that detects RFID tags attached to purchased goods carried by a customer, said RFID tag interrogator being associated to a computer;
b) a computer having storage means to store the different bands of frequency in which said RFID tags operate;
c) processing means stored on said computer, said processing means directing the system for performing the destruction process of RFID tags;
d) a database containing RFID identification data, said database being stored on said computer;
e) a device that emits electromagnetic pulses or any other particle emission to destroy said RFID tags, said device acting in conjunction with said computer;
f) an input device that allows the customer to direct the destruction process, said input device being connected and controlled by said computer and;
g) a display that shows the instructions for performing said destruction process, said display being connected and controlled by said computer.

12. The system of claim 11, wherein (a) (b) (e) (f) (g) are built into a doorway, passage, channel or any other similar entity separating two locations.

13. The system of claim 12, wherein (a) includes a sensor, said sensor allowing (a) to detect customers approaching said entities separating two locations, said sensor activating the RFID tag interrogator after detecting said customers.

14. The system of claim 12 further including means to attract attention and promote the destruction service to the customer.

15. The system of claim 12 further including means to demarcate the area where RFID tagged products have to be placed for destruction of the RFID tags.

16. The system of claim 11, wherein (a) (b) (e) (f) (g) are built into a belt running apparatus, said belt running apparatus comprising itself a driving assembly, a belt disposed in form of U and a covered passage whereby said driving assembly supplies movement to said belt, said belt being the place on which RFID tagged products are disposed, said belt running through said covered passage, said covered passage being the place where the destruction process is performed.

17. The system of claim 16 further including means to attract attention and promote the destruction service to the customer.

18. The system of claim 16 further including means to demarcate the area where RFID tagged products have to be placed for destruction of the RFID tags.

19. The system of claim 11, wherein (a) (b) (e) (f) (g) are built into a handheld device, said handheld device having an internal and an optional external power source, said handheld device having means for signaling the place where the goods have to be placed for the destruction process of RFID tags.
